(19) United States
(12) Patent Application Publication
(10) Pub. No.: US 2026/0037574 A1
(43) Pub. Date: Feb. 5, 2026

(54) WORKLOAD DISTRIBUTION BETWEEN EDGE AND CORE SYSTEMS

(71) Applicant: Dell Products L.P., Round Rock, TX (US)

(72) Inventors: BORIS SHPILYUCK, Ashdod (IL); MAXIM BALIN, Gan-Yavne (IL); IGOR DUBROVSKY, Beer Sheva (IL)

(21) Appl. No.: 18/788,270

(22) Filed: Jul. 30, 2024

(51) Int. Cl. G06F 16/735; G06F 16/2455

(52) U.S. Cl. CPC G06F 16/735; G06F 16/24568

(57) ABSTRACT

Methods and systems for providing computer implemented services are disclosed. To provide the services, information from a variety of systems may be aggregated. Prior to aggregation, the sources of the information may perform processes for enhancing the provided information. The processes may include removing information that is unlikely to benefit the computer implemented services, and identifying hidden information that is not explicitly noted but that is likely to benefit the computer implemented services. The processes may distribute the workload for preprocessing the aggregated information to reduce the likelihood of bottlenecks or other limits on throughput rate of the computer implemented services from occurring.

### FIELD

Embodiments disclosed herein relate generally to workload management. More particularly, embodiments disclosed herein relate to systems and methods to manage workloads for pre-processing of data used in computer implemented services.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows in accordance with an embodiment.

FIG. 3 shows a flow diagram illustrating a method of providing computer implemented services in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services. To provide the computer implemented services, information may be aggregated from various sources.

Prior to use in computer implemented services, the information may be pre-processed. To manage the workload for pre-processing of the information, the sources of the data may perform some pre-processing that is likely to reduce the workload on the entity that uses the aggregated information to provide computer implemented services.

The pre-processing may include removing information that is unlikely to benefit the computer implemented services (e.g., redundant information unlikely to enable insights to be developed), and adding information regarding hidden information that is not explicitly noted with metadata (e.g., pixels spelling out a word in a frame of a video may include the hidden information of the word).

By doing so, a system in accordance with an embodiment may provide a higher throughput rate for computer implemented services by distributing the pre-processing workload for information used to provide the computer implemented services. Thus, embodiments disclosed herein may address, among others, the technical problem of limitations on availability of computing resources to provide computer implemented services. The disclosed embodiments may address at least this technical problem by providing a data pre-processing workflow that more efficiently marshals limited computing resources. Accordingly, a system in accordance with an embodiment may provide improved computer implemented services.

In an embodiment, a method for managing data in a distributed system is provided. The method may include obtaining, by an entity that is remote to a data user, a data stream; filtering, by the entity, the data stream for relevant content to the data user to obtain a filtered data stream; signing, by the entity, the filtered data stream to obtain a signed filtered data stream; analyzing, by the entity, the signed filtered data stream to obtain metadata for the signed filtered data stream that is relevant to at least one use of the data stream by the data user; packaging, by the entity, the signed filtered data stream with the metadata to obtain an enhanced stream; and distributing, by the entity, the enhanced stream to facilitate provisioning of computer implemented services by the data user.

The data stream may include a media file.

Filtering the data stream for the relevant content may include comparing frames of the media to obtain similarity scores for each of the frames; adding a first portion of the frames having similarity scores that meet criteria; and discarding a second portion of the frames having similarity scores that do not meet the criteria.

Comparing the frames may include obtaining a first frame of the frames; obtaining a second frame of the frames that is temporally ordered immediately after the first frame of the frames; calculating a pixel-by-pixel difference between the first frame and the second frame to obtain a similarity score for the second frame; in a first instance of the calculating where the similarity score is below a threshold, marking the second frame for inclusion in the first portion; and in a second instance of the calculating where the similarity score is above the threshold, marking the second frame for inclusion in the second portion.

Analyzing the signed filtered data stream may include obtaining, for a frame from the signed filtered data stream, at least one selected from a group consisting of: a caption, a keyword, a location, and a timestamp.

Analyzing the signed filtered data stream may include obtaining, for a video segment from the signed filtered data stream, at least one selected from a group consisting of: a title, a description of content of the video segment; a keyword, and a timestamp of an occurrence in the video segment.

Analyzing the signed filtered data stream may include obtaining, for a video segment from the signed filtered data stream and using image recognition, at least one selected from a group consisting of: an object depicted in the video segment, a name of a person depicted in the video segment, a location depicted in the video segment, and a timestamp of a section of the video segment deemed relevant by the data user.

Analyzing the signed filtered data stream may include obtaining, for a video segment from the signed filtered data stream, a transcription.

Analyzing the signed filtered data stream may include obtaining, for a video segment from the signed filtered data stream, a summarization of content depicted in the video segment.

Packaging the signed filtered data stream with the metadata to obtain the enhanced stream may include generating associations between portions of the metadata with portions of the signed filtered data stream.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

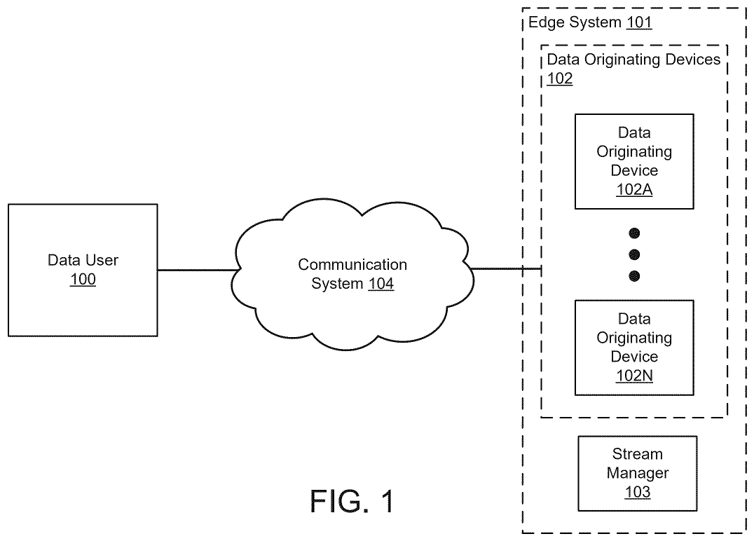

Turning to FIG. 1, a block diagram illustrating a system in accordance with an embodiment is shown. The system shown in FIG. 1 may provide computer-implemented services. The computer-implemented services may include data management services, data storage services, data access and control services, database services, and/or any other types of services that may be providing with a computing device.

To provide the services, information may be distributed across the system. For example, different components of the system may be distributed from each other, and may have access to different types of information. Some components may be able to obtain the information while others may need to use the information to provide the computer implemented services.

To enable different components to have access to the information for the services, the information may be transmitted via communication systems. For example, remote systems positioned where data may be collected may gather information. The information may then be transmitted to a hub or other designed entity within the system. The designated entity may then use the information (which may be obtained from one or multiple geographically distributed locations) to provide certain services.

However, when information is collected by a remote system, some or all of the information may not be helpful in providing the computer implemented services. For example, duplicative information aggregated at a particular location may not help in providing the computer implemented services. Thus, the aggregation location may needlessly consume computing resources processing the duplicative (and/or other types of unhelpful) information.

Further, some types of data may include hidden information. An image of a scene may, for example, include identifying information for an object in the scene that is not explicitly marked in the data. While the hidden information may be identified using various information extraction algorithms, if such data with hidden data is aggregated, the location of aggregation may have insufficient available resources to perform the information extraction algorithms (e.g., which may be further compounded if there are a large number of remote systems providing such information, establishing an N to 1 relationship between data originators and data users).

In general, embodiments disclosed herein may provide methods, systems, and/or devices for aggregating information and using the aggregated information to provide computer implemented services. To provide the computer implemented services, any number of data originating devices 102 may independently and/or cooperatively collect information. The information may be of any type and quantity.

As the information is collected, the information may be streamed to a data user (e.g., 100). The data user may utilize the data originating devices 102 to provide computer implemented services.

To manage the workload of data user 100 for providing such services, various systems such as edge system 101 that may include data originating devices may enhance the data prior to streaming it to data user 100. The enhancement process may reduce the quantity of information (e.g., while maintaining information relevant to services provided by data user 100) and extract/generate/identify hidden information from the original data. Thus, the resulting enhanced stream, when received by data user 100, may be usable with less processing by data user 100. Accordingly, data user 100 may be better able to provide computer implemented services through efficient marshalling of limited computing resources.

To provide the above noted functionality, the system of FIG. 1 may include data user 100, edge system 101, and communication system 104. Each of these components is discussed below.

Edge system 101 may be a remote system positioned near sources of data and/or otherwise away from core infrastructure such as data centers. Edge system 101 may collect information, providing various services, and/or otherwise contribute to the computer implemented services provided by the system of FIG. 1. To contribute to the services, edge system 101 may include data originating devices 102 and stream manager 103.

Data originating devices 102 may collect information relevant to other entities, and initiating streaming of the information to the other entities. For example, data originating devices 102 may collect information that may be relevant to computer implemented services provided by executing programs hosted by data user 100, and initiating providing of the information. Rather than sending the information directly, data originating devices 102 may provide the information through stream manager 103. Data originating devices 102 may include any number of data originating devices (e.g., 102A-102).

Data originating devices 102 may be include and/or be operably connected to devices which may collect, store, and/or manage data, various types of sensors connected to a computer that collects information (e.g., camera, microphone, etc.), and/or another type of data collection devices. For example, the sensors may collect images, video, and/or other media information regarding a scene.

Stream manager 103 may ingest data (e.g., media streams) from data originating devices 102 and generate enhanced streams. The enhanced streams may be transmitted to data users such as data user 100. While illustrated in FIG. 1 with a single data user, it will be appreciated that stream manager 103 may generate and transmit enhanced streams to any number of data users.

Data user 100, as noted above, may obtain information from any number of edge systems (e.g., 101, while shown with a single edge system in FIG. 1 a system may include any number), and providing computer implemented services using the obtained information. To obtain the information, data user 100 may provide stream managers of the edge systems with information regarding information relevant to the computer implemented services provided by applications hosted by data user 100. Any number and type of computer implemented services may be provided by data user 100.

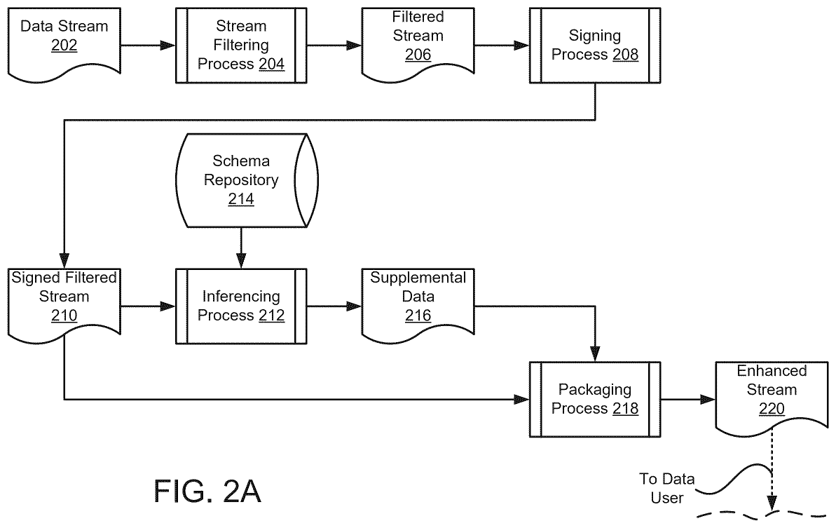

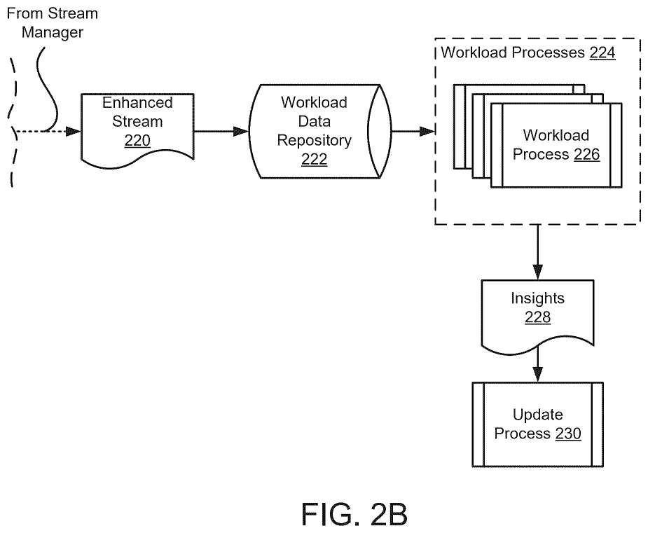

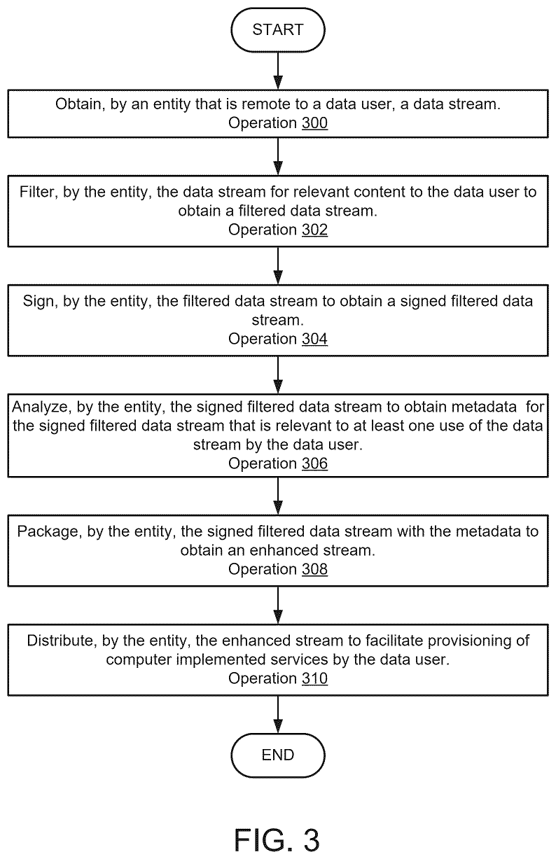

When providing their functionality, any of data user 100, and/or edge system 101 (and/or portions thereof) may perform all, or a portion, of the actions, flows, and methods shown in FIGS. 2A-3.

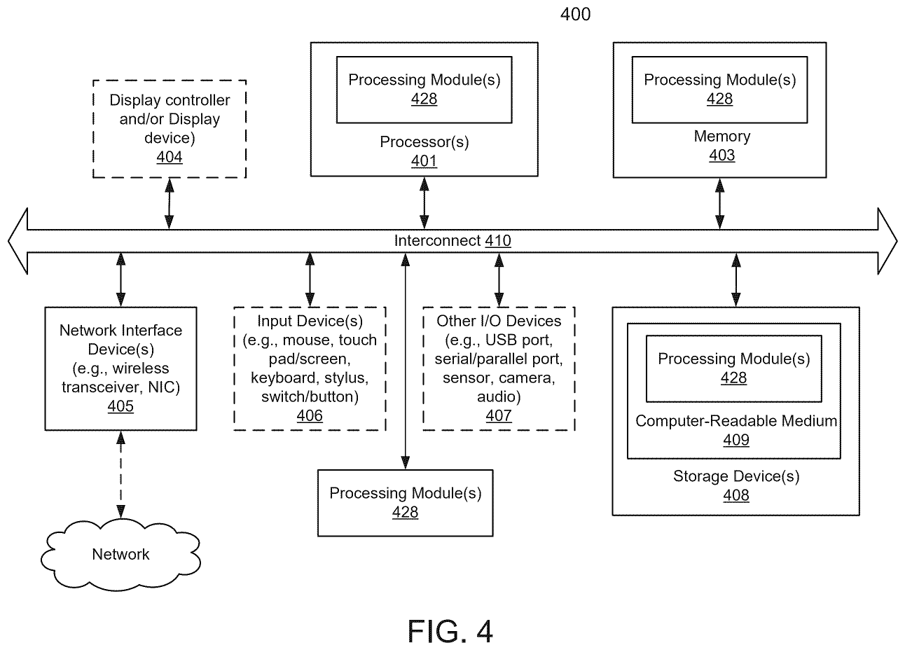

Any of (and/or components thereof) data user 100 and/or edge system 101 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 202, 206, etc.) is used to represent data structures, a second set of shapes (e.g., 204, 208, etc.) is used to represent processes performed using and/or that generate data, and a third set of shapes (e.g., 214, etc.) is used to represent large scale data structures such as databases.

Turning to FIG. 2A, a first data flow diagram in accordance with an embodiment is shown. The first data flow diagram may illustrate data used in and data processing performed in processing of data streams.

To process data stream 202, stream filtering process 204 may be performed. During stream filtering process 204, data stream 202 may be analyzed for redundant, irrelevant, and/or other types of data that may not be helpful in providing a computer implemented services.

For example, data stream 202 may be generated with a camera that monitors a scene (e.g., outside of a building). Data stream 202 may include any number of video frames, audio data, and/or other information regarding the scene. A data user may utilize information regarding the scene in provisioning of computer implemented services. For example, the services may take into account changing numbers of cars in a parking lot present in the scene. Overtime, the number of cars in the scene may not change. Consequently, multiple frames may be duplicative in that they do not illustrate changes in the number of cars in the parking lot. If all of the frames are sent to the data user, the data user may need to process each of the frames. To reduce the processing load on the data user, similarity levels between frames may be identified using any analysis algorithm. Frames deemed to be unchanged or within certain degrees of similarity (e.g., noise may cause pixel values in each frame to fluctuate) of each other may be considered to be duplicative. Such frames, during stream filtering process 204, may be removed.

For example, the frames may be divided into two portions. The first portion may include frames deemed to not be duplicative and the second portion may include frames deemed to be duplicative. Only the first portion may be added to filtered stream 206. The second portion may be discarded, or otherwise not provided to the data user (e.g., may be cached locally in case the frames are called for in the future). Similar processes may be performed for other types of information from data stream 202.

Filtered stream 206 may, consequently, include frames, audio segments, and/or other information that is more likely to include unique data, changes in data, etc. rather than data that is duplicative, cumulative, and/or otherwise unlikely to be useful.

Once filtered stream 206 (or portions thereof) is obtained, signing process 208 may be performed. During signing process 208, filtered stream 206 (or portions thereof) may be placed in a cryptographically verifiable state. For example, filtered stream 206 may be signed using a private key maintained by an edge system (or portions thereof). A corresponding public key may be available to a data user (e.g., through a key publication system, key directory, etc.).

Thus, the resulting signed filtered stream 210 may be verified by the data user using the public key. While described with respect to a public-private key infrastructure based process, it will be appreciated that other types of cryptographic verification infrastructure (e.g., symmetric key based systems, hash-based message authentication codes (HMAC), etc.) may be used without departing from embodiments disclosed herein.

Once signed filtered stream 210 (or portions thereof) is obtained, inferencing process 212 may be performed. During inferencing process 212, signed filtered stream 210 may be analyzed for hidden data. For example, various inference model, image recognition models, analysis roles, etc. may be obtained from schema repository 214.

Schema repository 214 may include any number of entities (e.g., inference models such as trained machine learning models, image recognition models, transcription algorithms, voice/object recognition models, etc.) usable to analyze media data such as images, videos, audio, etc. for hidden data. As used herein, hidden data may be information that may be extracted from data. For example, hidden data may include an arrangement of pixels spelling out a word, symbol, etc. that is not explicitly indicated by a media file but that may be derived from the media file. The entities from schema repository 214 may be usable to generate metadata that indicates the hidden data.

The metadata may include metadata for images, and metadata for videos (or other multi-modal media files).

For example, the metadata for images may include captions, keywords, location data (geotags), timestamps, etc.

In another example, the metadata for images and/or video may include high level metadata such as description, keywords, and relevant timestamps. The metadata may also include: (i) lower level metadata such as presence of objects, people, or places within images or video frames, and tags the objects; (ii) transcriptions for spoken language in the videos, (iii) sentiment expressed (e.g., positive, negative, neutral, etc.) in the videos, (iii) names and profiles of persons depicted in videos/images, (iv) objects present, trajectories/paths of the objects, etc., (v) key words or phrases usable to describe content from portions of images/videos, (vi) speech patterns, languages, specific sounds, etc. (e.g., audio analysis), (vii) context regarding the locations, persons, and/or other portions of the content of images/video, (viii) geospatial maps of locations and objects present at the locations, (ix) changes in characteristics (e.g., temperature, weather, condition, etc.) of the environment or objects depicted in scenes (e.g., time-series data), (x) categorizations such as topics or themes for content of the images/videos, and/or other types of information.

The specific metadata to be obtained may be specified by different data users. For example, schema repository 214 may also include preferences, configurations, etc. for different data users that enable the data user to define the relevant information provided to the data user.

These preferences may be established deterministically (e.g., the data user may specify them), be updated overtime (e.g., the data user may provide feedback regarding relevancy/utility of portions of provided data over time, the preferences may be updated using a reward model that reduces generation of metadata that is not relevant over time), etc.

The metadata obtained via inferencing process 212 may be stored as supplemental data 216.

Once supplemental data 216 is obtained for all or a portion of signed filtered stream 210, packaging process 218 may be performed. During packaging process 218, signed filtered stream and supplemental data 216 may be packaged to obtain enhanced stream. To package the data, portions of signed filtered stream 210 and corresponding portions of supplemental data 216 may be associated.

For example, portions of supplemental data 216 and pointers may be added to signed filtered stream 210. The pointers may associate the portions of supplemental data 216 with portions of signed filtered stream 210 from which the portions of supplemental data 216 are obtained.

For example, supplemental data 216 may include a list of objects present in a frame of signed filtered stream. During packaging process 218, the list of objects may be added to enhanced stream 220, and a pointer may be added that points between the list of objects in enhanced stream 220 and the frame in enhanced stream 220.

Once enhanced stream 220 (or portions thereof) is obtained, enhanced stream 220 may be provided to any number of data users.

Turning to FIG. 2B, a second data flow diagram in accordance with an embodiment is shown. The second data flow diagram may illustrate data used in and data processing performed in providing computer implemented services using enhanced streams.

To provide the computer implemented services, enhanced stream 220 may be stored in workload data repository 222. Workload data repository 222 may include any type and quantity of information from any number of enhanced streams (e.g., from different edge systems).

Information from workload data repository 222 may be used in any number of workload processes 224. Workload processes 224 may include any number of processes (e.g., 226, executing programs). Any of the processes may obtain and use information from workload data repository 222 to obtain insights 228.

As part of and/or separately from workload processes 224, the information from workload data repository 222 may be screened for relevancy to the processes. However, because enhanced streams may be utilized, the likelihood of any of the information in workload data repository 222 not being relevant may be reduced. Thus, the screening processes may be of lower complexity and/or computational cost when compared to performing similar processes for raw streams of data from edge systems.

The output of workload processes 224 may be any number and type of insights 228. The insights may depend on the type of process. The insights may be used as the output of the computer implemented services, and/or may be used to perform various update processes 230 for the edge systems. For example, insights 228 may include information regarding likely and/or existing operation of the edge systems. Such insights may be used to identify changes to the operation of the edge systems to enhance the services provided by the edge systems.

As part of update processes 230, any number of instructions may be sent to edge system components to update the operation of these components of the system. The instructions may cause the edge systems to, for example, (i) change functionality, (ii) change configuration settings, (iii) disable/enable hardware components, etc.

Thus, using the flows shown in FIGS. 2A-2B, embodiments disclosed herein may distribute data processing workloads across a distributed system that enables desired computer implemented services (e.g., workload processes 224) to be provided. Accordingly, resource constraints and/or bottlenecks in processing that may otherwise hinder such computer implemented services may be removed.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to provide computer implemented services using user input. FIG. 3 illustrates a method that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer implemented services in accordance with an embodiment is shown. The method may be performed by any of the components of the system of FIG. 1.

At operation 300, a data stream is obtained by an entity that is remote to a data user. The data stream may be obtained by reading it from storage, obtaining it from another entity, generating it, and/or via other methods.

The data stream may be generated using a sensor. The sensor may be camera. The camera may capture images, video, and/or audio from a scene (e.g., a media stream).

The entity may be a component of an edge system. The data user may be a core of a system, such as a data center or other entity not located with the sensor.

At operation 302, the data stream is filtered by the entity for relevant content to the data user to obtain a filtered data stream. The data stream may be filtered by removing duplicative and/or extraneous data (e.g., not relevant to a user of the data stream by the data user). For example, in video or images, frames may be analyzed to identify frames that are substantially duplicative (e.g., pixels changed less than 1% between the frames, which may be from different points in time in a time series).

At operation 304, the filtered data stream is signed by the entity to obtain a signed filtered stream. The filtered data stream may be signed using a signing algorithm (e.g., HMAC, public key infrastructure, etc.) and cryptographic data (e.g., keys).

At operation 306, the signed filtered data is analyzed by the entity to obtain metadata for the signed filtered data stream that is relevant to at least one use of the data stream by the data user. The signed filtered data may be analyzed using any number of analysis algorithms such as transcription algorithms, object recognition algorithms, etc. The metadata may be generated as output from the analysis algorithms.

At operation 308, the signed filtered data stream and metadata is packaged by the entity to obtain an enhanced stream. The signed filtered data stream and metadata may be packaged by associating portions of the metadata with corresponding portions of the signed filtered data stream (e.g., the corresponding portions may be source from which the portion of metadata is derived). The associations, portions of signed filtered stream, and metadata may be added/stored to obtain the enhanced stream.

Any number of data streams may be similarly analyzed and co-packaged with the information from the data stream. Thus, the resulting enhanced stream may include information obtained from any number of data originators (e.g., edge systems, connected sensors, etc.) across an edge system.

At operation 310, the enhanced stream is distributed by the entity to at least the data user to facilitate provisioning of computer implemented services by the data user.

The enhanced stream may be distributed by sending the enhanced stream over a secure communication channel.

Once obtained, the data user may use the enhanced stream to provide computer implemented services. For example, the enhance stream may be used natively and/or with small amounts of pre-processing by the data user.

The method may end following operation 310.

Using the methods illustrated in FIG. 3, embodiments disclosed herein may facilitate provisioning of computer implemented services in a distributed environment. The services may be facilitated by distributing the data pre-processing workload across multiple system components. Accordingly, data users may be less likely to be bottlenecks for throughput of computer implemented services.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data in a distributed system, the method comprising:
obtaining, by an entity that is remote to a data user, a data stream;
filtering, by the entity, the data stream for relevant content to the data user to obtain a filtered data stream;
signing, by the entity, the filtered data stream to obtain a signed filtered data stream;
analyzing, by the entity, the signed filtered data stream to obtain metadata for the signed filtered data stream that is relevant to at least one use of the data stream by the data user;
packaging, by the entity, the signed filtered data stream with the metadata to obtain an enhanced stream; and
distributing, by the entity, the enhanced stream to facilitate provisioning of computer implemented services by the data user.

2. The method of claim 1, wherein the data stream comprises a media file.

3. The method of claim 2, wherein filtering the data stream for the relevant content comprises:
comparing frames of the media file to obtain similarity scores for each of the frames;
adding a first portion of the frames having similarity scores that meet criteria; and
discarding a second portion of the frames having similarity scores that do not meet the criteria.

4. The method of claim 3, wherein comparing the frames comprises:
obtaining a first frame of the frames;
obtaining a second frame of the frames that is temporally ordered immediately after the first frame of the frames;
calculating a pixel-by-pixel difference between the first frame and the second frame to obtain a similarity score for the second frame;
in a first instance of the calculating where the similarity score is below a threshold, marking the second frame for inclusion in the first portion; and
in a second instance of the calculating where the similarity score is above the threshold, marking the second frame for inclusion in the second portion.

5. The method of claim 1, wherein analyzing the signed filtered data stream comprises:
obtaining, for a frame from the signed filtered data stream, at least one selected from a group consisting of:
a caption,
a keyword,
a location, and
a timestamp.

6. The method of claim 1, wherein analyzing the signed filtered data stream comprises:
obtaining, for a video segment from the signed filtered data stream, at least one selected from a group consisting of:
a title,
a description of content of the video segment;
a keyword, and
a timestamp of an occurrence in the video segment.

7. The method of claim 1, wherein analyzing the signed filtered data stream comprises:
obtaining, for a video segment from the signed filtered data stream and using image recognition, at least one selected from a group consisting of:
an object depicted in the video segment,
a name of a person depicted in the video segment,
a location depicted in the video segment, and
a timestamp of a section of the video segment deemed relevant by the data user.

8. The method of claim 1, wherein analyzing the signed filtered data stream comprises:
obtaining, for a video segment from the signed filtered data stream, a transcription.

9. The method of claim 1, wherein analyzing the signed filtered data stream comprises:
obtaining, for a video segment from the signed filtered data stream, a summarization of content depicted in the video segment.

10. The method of claim 1, wherein packaging the signed filtered data stream with the metadata to obtain the enhanced stream comprises:
adding associations between portions of the metadata with portions of the signed filtered data stream.

11. A non-transitory machine-readable medium having instructions stored therein, which when executed by a processor, cause operations for managing data in a distributed system to be performed, the operations comprising:
obtaining, by an entity that is remote to a data user, a data stream;
filtering, by the entity, the data stream for relevant content to the data user to obtain a filtered data stream;
signing, by the entity, the filtered data stream to obtain a signed filtered data stream;
analyzing, by the entity, the signed filtered data stream to obtain metadata for the signed filtered data stream that is relevant to at least one use of the data stream by the data user;
packaging, by the entity, the signed filtered data stream with the metadata to obtain an enhanced stream; and
distributing, by the entity, the enhanced stream to facilitate provisioning of computer implemented services by the data user.

12. The non-transitory machine-readable medium of claim 11, wherein the data stream comprises a media file.

13. The non-transitory machine-readable medium of claim 12, wherein the filtering the data stream for the relevant content comprises:
comparing frames of the media file to obtain similarity scores for each of the frames;
adding a first portion of the frames having similarity scores that meet criteria; and
discarding a second portion of the frames having similarity scores that do not meet the criteria.

14. The non-transitory machine-readable medium of claim 13, wherein comparing the frames comprises:
obtaining a first frame of the frames;
obtaining a second frame of the frames that is temporally ordered immediately after the first frame of the frames;
calculating a pixel-by-pixel difference between the first frame and the second frame to obtain a similarity score for the second frame;
in a first instance of the calculating where the similarity score is below a threshold, marking the second frame for inclusion in the first portion; and
in a second instance of the calculating where the similarity score is above the threshold, marking the second frame for inclusion in the second portion.

15. The non-transitory machine-readable medium of claim 11, wherein analyzing the signed filtered data stream comprises:
obtaining, for a frame from the signed filtered data stream, at least one selected from a group consisting of:
a caption,
a keyword,
a location, and
a timestamp.

16. A data processing system, comprising:
a processor; and
a memory coupled to the processor to store instructions, which when executed by the processor, cause operations for managing data in a distributed system to be performed, the operations comprising:
obtaining, by an entity that is remote to a data user, a data stream;
filtering, by the entity, the data stream for relevant content to the data user to obtain a filtered data stream;
signing, by the entity, the filtered data stream to obtain a signed filtered data stream;
analyzing, by the entity, the signed filtered data stream to obtain metadata for the signed filtered data stream that is relevant to at least one use of the data stream by the data user;
packaging, by the entity, the signed filtered data stream with the metadata to obtain an enhanced stream; and
distributing, by the entity, the enhanced stream to facilitate provisioning of computer implemented services by the data user.

17. The data processing system of claim 16, wherein the data stream comprises a media file.

18. The data processing system of claim 17, wherein the filtering the data stream for the relevant content comprises:
comparing frames of the media file to obtain similarity scores for each of the frames;
adding a first portion of the frames having similarity scores that meet criteria; and
discarding a second portion of the frames having similarity scores that do not meet the criteria.

19. The data processing system of claim 18, wherein comparing the frames comprises:
obtaining a first frame of the frames;
obtaining a second frame of the frames that is temporally ordered immediately after the first frame of the frames;
calculating a pixel-by-pixel difference between the first frame and the second frame to obtain a similarity score for the second frame;
in a first instance of the calculating where the similarity score is below a threshold, marking the second frame for inclusion in the first portion; and
in a second instance of the calculating where the similarity score is above the threshold, marking the second frame for inclusion in the second portion.

20. The data processing system of claim 16, wherein analyzing the signed filtered data stream comprises:
obtaining, for a frame from the signed filtered data stream, at least one selected from a group consisting of:
a caption,
a keyword,
a location, and
a timestamp.
